(19) United States
(12) Patent Application Publication
(10) Pub. No.: US 2021/0344146 A1
(43) Pub. Date: Nov. 4, 2021

(54) ELECTRICAL CONNECTOR INCLUDING A MOVABLE TERMINAL HAVING A SUBSTANTIALLY VERTICAL SECURING PORTION WITH A PAIR OF SIDE ARMS INSERT-MOLDED WITH AN INSULATIVE BASE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: MING-CHING CHEN, New Taipei (TW)

(21) Appl. No.: 17/242,436

(22) Filed: Apr. 28, 2021

(30) Foreign Application Priority Data
Apr. 30, 2020 (CN) 202010364260.2

(51) Int. Cl. H01R 24/40; H01R 13/631; H01R 13/40

(52) U.S. Cl. CPC H01R 24/40; H01R 2103/00; H01R 13/40; H01R 13/6315

(57) ABSTRACT

An electrical connector includes: an insulative base; a fixed terminal secured to the insulative base; and a movable terminal including a securing portion fixed to the insulative base, a contacting portion in touch with the fixed terminal, and a tail opposite to the contacting portion, wherein the securing portion has a pair of side arms bent toward the fixed terminal and insert-molded with the insulative base.

### BACKGROUND OF THE INVENTION

### 1. Field of the Invention

The present invention relates to an electrical connector comprising an insulative base, a fixed terminal (3) secured to the insulative base, and a movable terminal including a securing portion fixed to the insulative base, wherein the securing portion has features for securely fixing with the insulative base.

### 2. Description of Related Arts

China Patent No. 105826768 discloses a radio frequency (RF) electrical connector comprising an insulative base, a fixed terminal secured to the insulative base, and a movable terminal including a securing portion fixed to the insulative base, a contacting portion in touch with the fixed terminal, and a tail opposite to the contacting portion. Since the RF connector is of a very small size, securement between the movable terminal securing portion and the insulative base may be insufficient under repeated use.

### SUMMARY OF THE INVENTION

An electrical connector comprises: an insulative base; a fixed terminal secured to the insulative base; and a movable terminal including a securing portion fixed to the insulative base, a contacting portion in touch with the fixed terminal, and a tail opposite to the contacting portion, wherein the securing portion has a pair of side arms bent toward the fixed terminal and insert-molded with the insulative base.

### BRIEF DESCRIPTION OF THE DRAWING

FIG. 1 is a perspective view of an electrical connector in accordance with the present invention;

FIG. 2 is another perspective view of the electrical connector;

FIG. 3 is an exploded view of the electrical connector;

FIG. 4 is a further exploded view of the electrical connector;

FIG. 5 is a view similar to FIG. 4 but from another perspective; and

FIG. 6 is a cross-sectional view of the electrical connector taken along line A-A in FIG. 1.

### DETAILED DESCRIPTION OF THE PREFERRED EMBODIMENTS

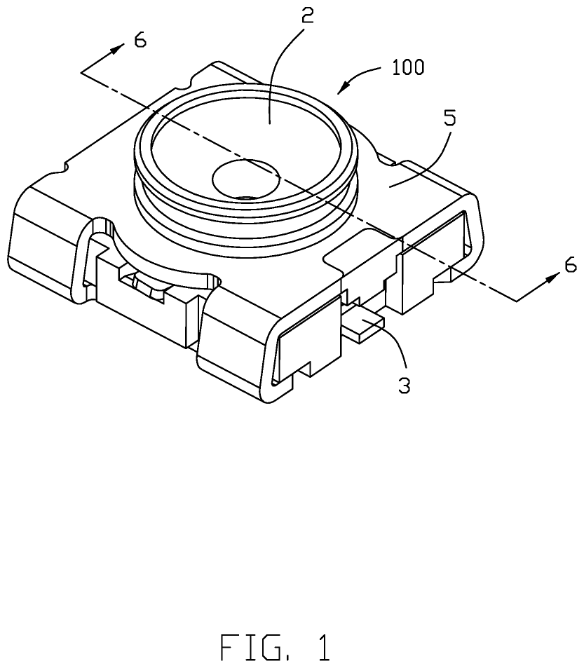

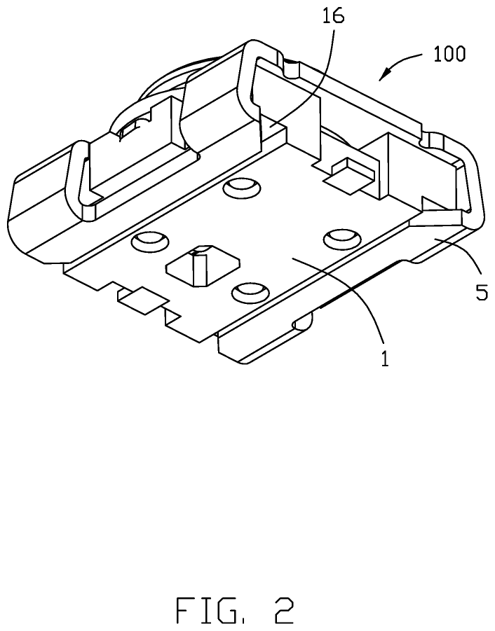

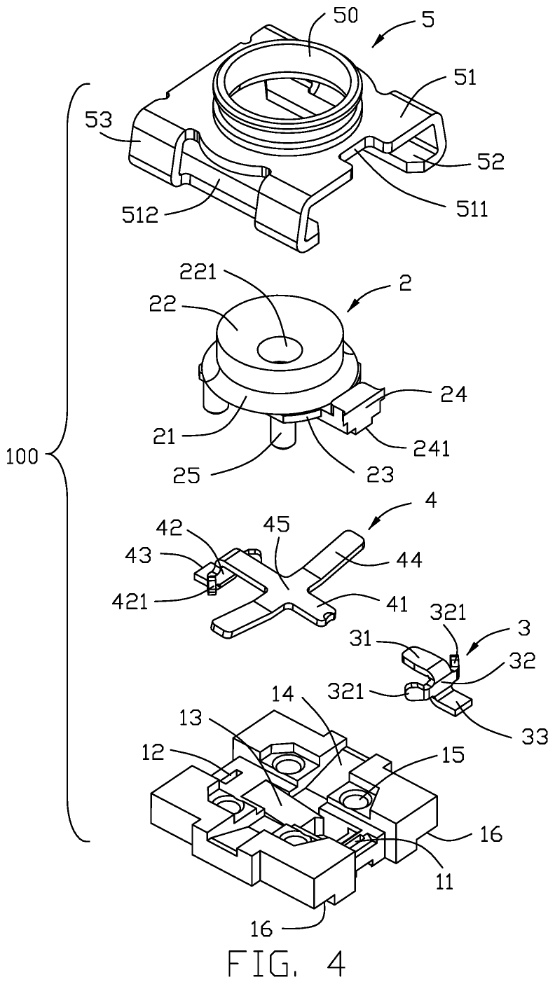

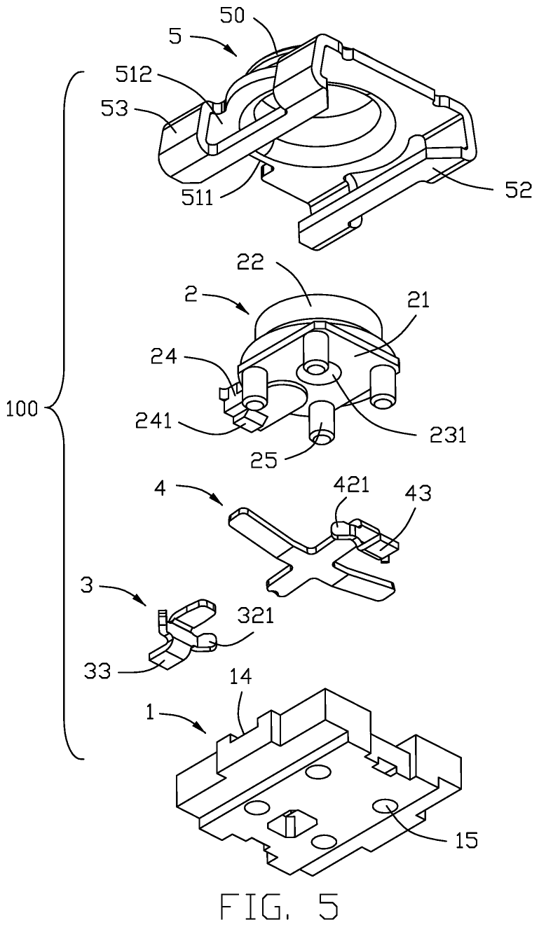

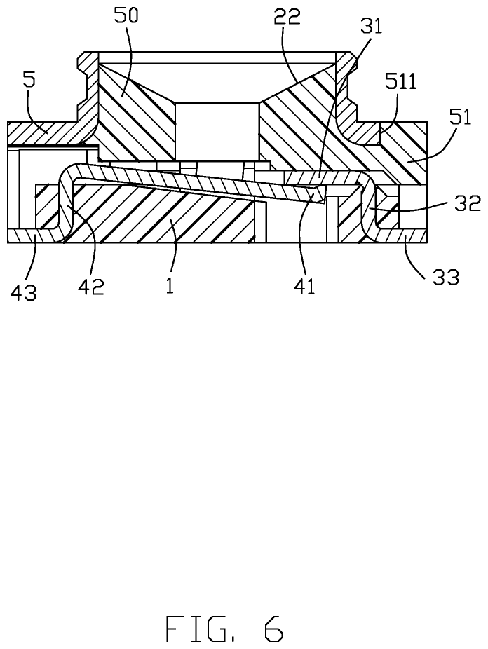

Referring to FIGS. 1-6, an RF electrical connector 100 comprises an insulative base 1, a fixed terminal 3 secured to the insulative base 1, and a movable terminal 4 including a securing portion 42 fixed to the insulative base 1. The movable terminal 4 and the fixed terminal 3 are normally closed, i.e., in touch with each other. The electrical connector 100 may further comprise an insulative cover 2 secured to the insulative base 1 and an outer metallic shell 5 enclosing the insulative cover 2 and the insulative base 1.

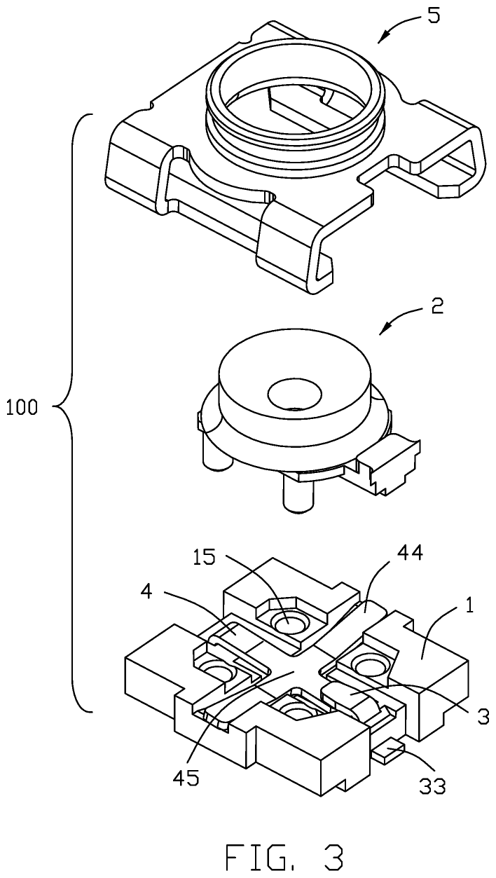

Referring specifically to FIGS. 3-6, the insulative base 1 has a first groove 11 for the fixed terminal 3, a second groove 12 for the movable terminal 4, a supporting groove 13, an abutting groove 14 orthogonal to the groove 13, plural holes 15, and a pair of bottom grooves 16.

The insulative cover 2 includes a base portion 21, a mating portion 22, a bottom plate 23, an engaging block 24, and four posts 25. The insulative cover 2 has a central hole 221/231. The block 24 has an abutment 241 abutting against the fixed terminal 3. The posts 25 enter the holes 15.

The fixed terminal 3 has a securing portion 32, a soldering tail 33, and a contacting portion 31. The securing portion 32 is substantially vertical and has a pair of side arms 321 bent toward the movable terminal 4 and insert-molded with the insulative base 1. The contacting portion 31 is bent to its position after the fixed terminal 3 is insert-molded with the insulative base 1 so as to achieve an accurate positioning of the contacting portion 31 relative to the movable terminal 4. Each of the pair of side arms 321 is substantially vertical and is bent about 45 degrees.

The movable terminal 4 has a securing portion 42, a contacting portion 41 in touch with the contacting portion 31 of the fixed terminal 3, a soldering tail 43, and a pair of beams 44. The securing portion 42 is substantially vertical and has a pair of side arms 421 bent toward the fixed terminal 3 and insert-molded with the insulative base 1. Between the pair of beams 44 on the contacting portion is a pressing portion 45 for being pressed by a probe inserted through the hole 221/231. Each of the pair of side arms 421 is substantially vertical and is bent about 45 degrees.

The metallic shell 5 has a base 51, a socket 50, and a pair of retaining portions 52 bent from the base 51. The base 51 has a notch 511 for engaging the block 24 of the insulative cover 2. Each retaining portion 52 has a slot 512 and a connecting portion 53. A bottom of the retaining portion 52 is received in the bottom groove 16.

The pair of side arms 321 of the fixed terminal 3 significantly increase retention of the terminal 3 to the insulative base 1 in a limited space, so do the pair of side arms 421 of the movable terminal 4 which is especially subject to frequent movement in use.

What is claimed is:

1. An electrical connector comprising:
an insulative base;
a fixed terminal secured to the insulative base; and
a movable terminal including a securing portion fixed to the insulative base, a contacting portion in touch with the fixed terminal, and a tail opposite to the contacting portion; wherein
the securing portion has a pair of side arms bent toward the fixed terminal and insert-molded with the insulative base.

2. The electrical connector as claimed in claim 1, wherein the securing portion of the movable terminal is substantially perpendicular to the contacting portion and the tail.

3. The electrical connector as claimed in claim 1, wherein the fixed terminal includes a substantially vertical securing portion having a pair of side arms insert-molded with the insulative base.

4. The electrical connector as claimed in claim 3, wherein the fixed terminal includes a contacting portion bent to a substantially horizontal position from the securing portion thereof after the fixed terminal is insert-molded with the insulative base.

5. The electrical connector as claimed in claim 1, wherein each of the pair of side arms is bent about 45 degrees.

6. The electrical connector as claimed in claim 1, further comprising an insulative cover secured to the insulative base and covering the fixed terminal and the movable terminal.

7. The electrical connector as claimed in claim 1, further comprising an outer metallic shell enclosing the insulative cover and the insulative base.
